(19) United States
(12) Patent Application Publication
(10) Pub. No.: US 2007/0256027 A1
(43) Pub. Date: Nov. 1, 2007

(54) Control System for a Motor Vehicle

(75) Inventor: Rainer Daude, Unterschleissheim (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 10/584,459

(22) PCT Filed: Nov. 20, 2004
(86) PCT No.: PCT/EP04/13210

§ 371 Date: Jun. 26, 2007

(30) Foreign Application Priority Data
Dec. 23, 2003 (DE) 103 60 655.6

(51) Int. Cl. G06F 3/048

(52) U.S. Cl. 715/810

(57) ABSTRACT

A control system for a vehicle having a screen display with a plurality of display areas for displaying entries of a menu structure, a manual actuating means for selecting and/or activating at least one entry in a current menu level, voice control means for redundantly selecting and/or activating at least one entry from the menu structure which simultaneously forms a keyword for the voice control means. The entries of the menu structure are divided into various groups, a first group of entries can be selected and/or activated only with the manual actuating means, a second group of entries can be selected and/or activated with the manual actuating means and/or the voice control means, and the second group being divided into at least two groups of terms which can be ordered by simple rules and which determine which keywords can be input at a particular time for menu control.

This application is a national phase application of International application PCT/EP2004/013210 filed Nov. 20, 2004 and claims the priority of German application No. 103 60 655.6, filed Dec. 23, 2003, the disclosure of which are expressly incorporated by reference herein.

### BACKGROUND AND SUMMARY OF THE INVENTION

The invention relates to a control system for a vehicle having a screen display, a manual actuating means and voice control means.

In modern vehicles, multimedia control systems are being increasingly used. An example of this is the command system in the Mercedes Benz S-class.

German patent publication DE 197 52 056 A1 describes a control system for a motor vehicle. In this control system, two display areas are displayed on a screen display in a menu structure with a plurality of menu levels. A first display area is arranged as a frame around the second display area. In a first menu level, eight fields with entries which correspond to applications which can be carried out and which are arranged vertically and horizontally are displayed in the first display area. An entry is selected by means of a pushing or tilting movement of the manual actuating means with a plurality of degrees of freedom of adjustment in the direction of the position of the corresponding entry in the first display area. A selected entry is activated by pressing the manual actuating means. After the activation, a plurality of vertically arranged entries which are assigned to the activated entry in the first menu level are displayed in a second menu level in the second display area. The entries displayed in the second display area are selected by means of rotational movement of the manual actuating means and activated by pressing the manual actuating means. The activated second display area and the second menu level are exited by means of the pushing or tilting movement of the manual actuating means in the direction of a position of one of the entries in the first display area. The control system is then located in the first menu level in the first display area again.

European patent publication EP 1 342 605 A1 describes a control system for a motor vehicle having a screen display, a manual actuating means with a plurality of degrees of freedom of adjustment and voice control means. The screen display comprises a plurality of display areas for displaying entries of a menu structure with a plurality of menu levels it being possible to select and/or activate the entries of the menu structure using the manual actuating means and/or the voice control means. The entries of the menu structure which are displayed on the screen display simultaneously form the keywords which can be input at a particular time for voice-operated menu control.

U.S. Pat. No. 4,827,520 describes a control system for a motor vehicle having a screen display, a plurality of manual actuating means which are arranged in the surroundings of the screen display and voice control means. The screen display comprises a plurality of display areas for displaying entries of a menu structure with a plurality of menu levels, it being possible to select and/or activate the entries of the menu structure by means of the manual actuating means and/or the voice control means. The entries of the menu structure which are displayed on the screen display or on the manual actuating means simultaneously form the keywords which can be input at a particular time for voice-operated menu control.

U.S. Pat. No. 4,797,924 describes a control system for a motor vehicle having a screen display, a plurality of manual actuating means and voice control means. The various vehicle components such as the telephone system, radio etc. can be controlled either using the manual actuating means or the voice control means. For the purpose of voice control, the terms which can be input are ordered in a hierarchical command structure with a plurality of command levels, in which case only terms of a current command level can be input and are understood and executed by the voice control means.

The object of the invention is to specify an improved control system for a vehicle by means of which intuitive voice control is made possible and the operating convenience is improved.

The invention is based on the idea of dividing entries of a menu structure which is displayed on a screen display with a plurality of menu levels into various groups, a first group comprising entries which can be selected and/or activated only with a manual actuating means. A second group comprises entries which can be selected and/or activated with the manual actuating means and/or voice control means. In addition, the entries of the second group are divided into at least two groups of terms which are defined by simple rules and which determine which keywords for menu control can be input by means of voice at a particular time, i.e. in the current menu level and/or in the currently active display area.

The control system according to the invention enables the user to control the menu structure with a plurality of menu levels using voice control means and/or the manual actuating means. The entries which are assigned to the first group comprise, for example, setting processes for variable parameters such as volume, balance, bass, treble, fade, transmitter selection of a conveyor belt which is animated in an analog fashion or a cursor for a radio application etc. which can be set most easily with the manual actuating means, for example by means of a continuous adjustmental movement. The entries which are assigned to the second group and which can be operated with the voice control means and/or the manual actuating means are simultaneously used as a possible keyword for the voice control and divided according to the invention into a plurality of groups of terms in order to permit the user to change over rapidly between applications and/or the menu levels.

The entries can be divided up, for example, as a function of the various display areas and/or menu levels. A possible rule is, for example, that all the entries of a first display area can only be controlled manually, all the entries of a second, fourth and fifth display area can be controlled manually and/or by voice, and the entries of a third control area can be controlled manually in a first and second menu level and/or by means of voice, and in a third menu level can only be controlled manually.

By dividing the keywords into a plurality of groups of terms, with the groups of terms differing, for example, in the menu level and/or the display area in which the keywords contained in the respective group of terms can be input, the voice control means can be adapted to the requirements of various users.

In one refinement of the invention, the definition rules can be used to assign the keywords to various groups of terms so that, for example, the keywords which are displayed at a particular time in an active display area of the screen display can be assigned to a first group of terms which are made available to the voice control means as a first partial vocabulary. These keywords indicate, for example, to a user which input is expected from him in the display area which is currently active and/or in the current menu level. As a result, an unpracticed user who only has to use these keywords for control is reliably guided through the menu structure.

In a further configuration, local keywords can be assigned to a second group of terms which are made available to the voice control means as a second partial vocabulary in addition to the first partial vocabulary, the local keywords which can be input being dependent on the current menu level. As a result, with more practice it is possible for a user to input by voice keywords which are not displayed in the currently active display area by means of entries but rather are associated with the direct surroundings of the selected application.

In a further configuration it is possible to assign global keywords to a third group of terms which are made available to the voice control means as a third partial vocabulary in addition to the first and second partial vocabularies, and are independent of the current menu level.

Through the use of the currently displayed entries as keywords for the voice control means, an unpracticed user is enabled to easily and reliably grasp the possible keywords in the currently displayed screen display and select the associated entries and activate them, which improves the intuitive voice control and increases the operating convenience for the unpracticed user.

As a result of the additional global and local keywords, a practiced user is enabled, when performing voice control, to jump over menu levels within the menu structure and also input invisible terms by means of voice on the current screen display since it can be assumed that the practiced user has committed to memory at least selected keywords or keyword combinations after a certain period of use. In addition, the division into different groups makes it possible to ensure that the function which matches the current menu level or the active display area of the screen display is carried out if various functions or various scopes of functions are assigned to a keyword in various menu levels. This also increases the operating convenience for a practiced user.

By inputting an entry by voice it is possible to trigger the same functionality as when a corresponding manual input is made using the manual actuating means, for example when a keyword from the third group of terms is input by voice.

Additionally or alternatively, the functionality can be restricted after a voice input compared to a manual input, for example when a keyword is input by voice from the first or second group of terms, the restriction of the functionality being dependent on the current menu level and/or on the active display area. For example it is possible to provide that a voice input selects a specific entry, i.e. places a cursor on this entry, and that the entry is activated by an additional manual control procedure, for example by pressing the manual actuating means. In addition it is possible to provide that opened display areas can be closed as a function of the menu level only by means of a manual input and remain opened after a voice input. Furthermore it may be more advantageous from the user's point of view to activate directly an entry by voice input or by manual input and to permit inclusive setting, for example of a parameter, exclusively using the manual actuating means.

In one configuration of the control system according to the invention, entries which are input from a list by voice are identified, for example, by means of numbering placed in front of them or after them. In order to select and/or activate the entry by means of a voice input it is then possible to input both the entry which is identified by the numbering system and the corresponding digit of the numbering system by voice.

Additionally or alternatively it is possible for the entries which can be input by voice to be identified by means of a particular visual representation on the screen in which the entries which can be input by voice are identified by a different color and/or a different intensity and/or a different size and/or a different shape.

If different functions which can be carried out are assigned to a keyword as a function of the menu level and/or the active display area, the function of the current menu level and/or of the active display area is carried out when such a keyword is input by voice.

In one application of the control system according to the invention in a motor vehicle, the third group of terms comprises, for example, in each case a keyword for application groups which can be controlled in the vehicle such as navigation system, audio system, telephone/communications system, video/TV system, air conditioning system and/or vehicle comfort systems such as duration of night lights in the passenger compartment lighting system, seat adjustment means etc., with which the respective application group can be selected and/or activated. In addition, the third group of terms can comprise keywords for applications of these groups of applications which can be selected from corresponding application menus. In the case of an audio system, the associated audio application menu comprises, for example, the subapplications of radio, CD, DVD etc. which can then be respectively selected by means of a global keyword. Furthermore, global keywords are provided for returning to the previous screen display, for example “back”, and for aborting the current voice input, for example “error” or “abort”.

The second group of terms comprises, for example, all the keywords for functions which are assigned to the respective application and which can be input by voice, irrespective of whether or not they are currently displayed in the active display area.

Keywords of the first group of terms are preferably all the entries for subfunctions of the selected function which are displayed in the currently active display area.

In addition, the keywords can also comprise dynamic entries from the three groups of terms, said dynamic entries changing on the basis of variable peripheral conditions, for example names of currently receivable radio transmitters, or changing system states, for example functions and/or subfunctions and/or options which can be carried out and which are dependent on the current system state.

Other objects, advantages and novel features of the present invention will become apparent from the following detailed description of the invention when considered in conjunction with the accompanying drawings for example.

### BRIEF DESCRIPTION OF THE DRAWINGS

FIG. 1 is a block circuit diagram of a control system for a motor vehicle in accordance with an embodiment of the present invention;

FIG. 2 is a schematic illustration of a screen display from FIG. 1 in a first menu level;

FIG. 3 is a schematic illustration of the screen display from FIG. 1 in a third menu level;

FIG. 4 is a schematic illustration of the screen display from FIG. 1 in a second menu level;

FIG. 5 is a schematic illustration of the screen display from FIG. 1 in a third menu level;

FIG. 6 is a schematic illustration of the screen display from FIG. 1 in a fourth menu level;

FIG. 7 is a schematic illustration of the screen display from FIG. 1 in a fifth menu level; and

FIG. 8 is a schematic illustration of the screen display from FIG. 1 in a second menu level.

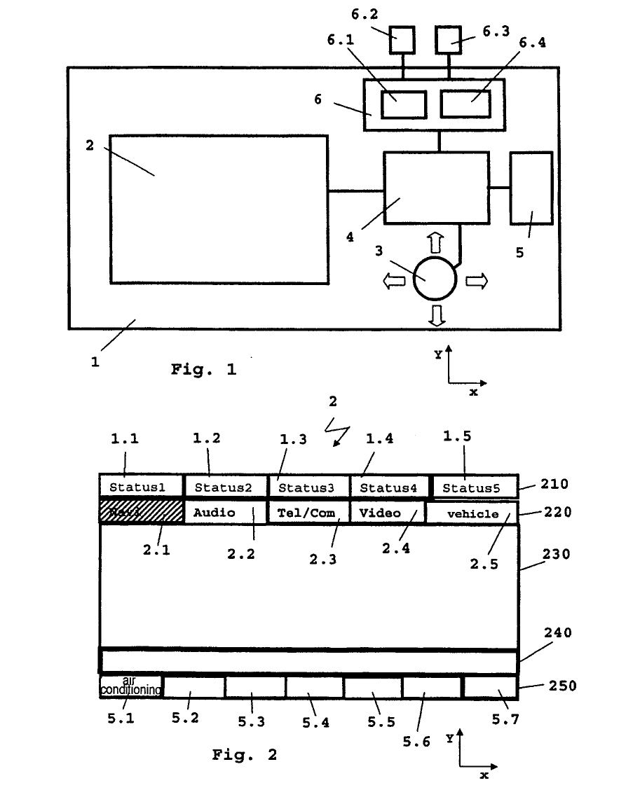

As is apparent from FIG. 1, the control system 1 for a motor vehicle comprises a screen display 2, a manual actuating means 3, a control and evaluation unit 4, voice control means 6, and a plurality of vehicle systems such as a navigation system, a heating system and an air conditioning system, a cellular telephone, a video system, an audio system etc. which are illustrated combined as one element 5. The vehicle systems transmit signals to the evaluation and control unit 4 from which the control and evaluation unit 4 determines current system states. All the applications and/or functions and/or subfunctions and/or options and/or status displays in various menu levels of a menu structure are controlled by means of the manual actuating means 3. In addition it is possible to control predefined applications and/or functions and/or subfunctions and/or options and/or status displays in various menu levels of the menu structure in a redundant fashion with respect to control with the manual actuating means 3, using the voice control means 6 by means of a corresponding voice input.

The voice control means 6 comprise, for example, voice input means 6.2, for example at least a microphone, a voice recognition unit 6.1, voice output means 6.3, for example at least one loudspeaker and at least one memory unit 6.4.

For the purpose of voice control, keywords for the voice control means 6 are divided into at least two groups of terms which can be defined by simple rules and which determine which keywords can be currently input for the purpose of menu control. A first group of terms comprises entries which are displayed at a particular time in an active display area of the screen display 2 and which simultaneously make available a first partial vocabulary as keywords to the voice control means 6. The keywords of the first group of terms are therefore dependent on the active display area and/or on the menu level. A second group of terms comprises local keywords which are made available as a second partial vocabulary to the voice control means 6 in addition to the first partial vocabulary and are dependent on the current menu level. A third group of terms comprises global keywords which are made available to the voice control means 6 as a third partial vocabulary in addition to the first and second partial vocabularies and are independent of the current menu level and/or of the active display area. When a keyword which is assigned to at least two groups of terms is input by voice, the function which is assigned to the current menu level and/or the active display area is carried out.

The entries which are displayed on the screen display 2 and which can be input by voice may have an identification which is implemented, for example, as a particular visual display and can be brought about by means of a different color and/or a different intensity and/or a different size and/or a different shape. This is represented by bold in FIGS. 2 to 8.

The manual actuating means 3 has seven degrees of freedom of adjustment for selecting and/or activating entries displayed in an active display area. Said actuating means 3 can be pushed in four directions according to the arrow illustration in FIG. 1, i.e. in a positive x direction, a negative x direction, in a positive y direction or in a negative y direction. In addition, it can be rotated in the clockwise direction or in the counter clockwise direction about a z axis (not illustrated) which is perpendicular to the plane of the drawing, and can be pressed in the direction of the negative z direction, i.e. into the plane of the drawing.

Rotating the manual actuating means 3 in the clockwise direction causes a cursor on the screen display 2 to move to the right or downward as a function of a horizontal or vertical orientation of the entries displayed on the screen display 2, and turning in the counter clockwise direction causes the cursor to move to the left or upward. Pushing the manual actuating means 3 in FIG. 1 upward, i.e. forward in the direction of the windshield, i.e. in the positive y direction, causes the cursor on the screen display 2 to move upward, and the pushing process in the downward direction in FIG. 1, i.e. toward the rear in the negative y direction, causes the cursor on the screen display 2 to move downward. Pushing to the right, i.e. in the positive x direction, causes the cursor on the screen display 2 to move to the right, and pushing to the left, i.e. in the negative x direction, causes the cursor to move to the left.

The selection and/or activation of an entry displayed on the screen display 2 are carried out by pushing or turning the manual actuating means 3. The manual actuating means 3 can be rotated about the z axis in a redundant fashion with respect to the vertical pushing along an axis, i.e. with respect to the pushing in the y direction, or with respect to the horizontal pushing along an axis, i.e. with respect to the pushing in the x direction. The pushing direction for selecting an entry corresponds here to the orientation of the entries displayed in the active display area. The pushing direction, which is respectively orthogonal to the selection pushing direction causes the active display area to be exited. In addition, in order to activate a selected entry it may be necessary to press the manual actuating means 3.

As is clear from FIG. 2, the screen display 2 comprises, in a first menu level, a graphic basic structure of five vertically arranged, horizontal display areas 210 to 250. This graphic basic structure is constant over the multiplicity of various menu levels of the menu structure. The screen display 2 is configured, for example, as an eight inch screen with a ratio of the sides of 15:9.

The graphic basic structure of the display area 230 is variable over the multiplicity of various menu levels of the menu structure as a function of an activated application and/or function and/or subfunction and/or option and/or status display, i.e. this central display area 230 may be configured graphically in very different ways.

One or more horizontally arranged entries 1.1 to 5.7 may be respectively displayed in the four display areas 210, 220, 240 and 250. For example, the display areas 210, 220, 240 and 250 in FIG. 2 in the first menu level each comprise a different number of entries. For example, the first display area 210 comprises five entries 1.1 to 1.5, the second display area 220 comprises five entries 2.1 to 2.5, the fourth display area comprises no entry and the fifth display area comprises seven entries 5.1 to 5.7. In FIG. 2, the second display area 220 is activated and the hatched entry 2.1 (Navi) is selected. The hatched display is intended to indicate that the cursor is positioned on the entry 2.1.

The entries 1.1 to 5.7 of the display areas 210 to 250 displayed on the screen display 2 can be arranged in accordance with the importance of their contents or frequency of application.

The schematic illustration of the screen display 2 in FIGS. 2 to 8 is adapted to the control for a motor vehicle with specific entries. As is apparent from FIG. 2, the first display area 210 is configured as a status line which presents various status displays 1.1 to 1.5 from different applications. The main function of the status line is to display important current system states which are determined by the control and evaluation unit 4 as a function of signals from the vehicle systems 5. The entries and status displays 1.1 to 1.5 can be selected and activated in the illustrated exemplary embodiment only with the manual actuating means 3. In order to determine the current system states, for example the signals from the navigation system with a locating unit, from the heating and air conditioning system, from the cellular telephone, from the video system, from the audio system etc. are evaluated. In the status line it is indicated, for example, whether a traffic radio transmitter is activated, whether the heating and air conditioning system is operating in the recirculation mode or fresh air mode, whether the active carbon filter is activated etc.

The first display area 210 which is configured as a status line can contain a plurality of controllable and uncontrollable entries 1.1 to 1.5 which are input into the display or removed from it as a function of the system state. The controllability of a number of entries can permit direct access to important functions without making it necessary to change the application. If an entry is selected from the status line, this can lead directly to an associated function. For example, by activating a letter symbol it is possible to activate and open a display area in a ComTel application, i.e. in a communication or telephone application. Activating a telephone receiver symbol can activate and open a different display area in the ComTel application group. Activating a TP symbol deactivates a traffic program, i.e. a traffic radio transmitter. In addition, various nonselectable status displays such as a satellite key can be displayed in order to display the GPS reception or a field strength.

The second display area 220 is embodied as an application line for displaying various selectable and predefinable application groups 2.1 to 2.5, in particular a navigation application group (Navi), an audio application group, a telephone/communications application group (Tel/Com), a video application group and a vehicle application group, the number and position of the entries to be displayed, i.e. the application groups 2.1 to 2.5 being constant and the graphic representation of the entries to be displayed being variable as a function of an activated application group. The activation of one of the application groups 2.1 to 2.5 which is not already active leads to a change into the associated application and to activation of the fourth display area 240 in order to display functions and/or subfunctions which are associated with the activated application. If an application does not have functions or subfunctions, the third display area 230 can be activated by activating this application in the second display area 220, and the options associated with this application for the purpose of control are displayed.

The arrangement of the application groups in the second display area 220 is constant and can be ordered from left to right according to frequency of use or importance. Selecting an application or application group brings about direct activation of at least one other display area and can be carried out by manual input with the manual actuating means 3 or by voice input using the voice control means. The entries 2.1 to 2.5 of the application line 220 which are identified by bold are assigned as keywords to the first group of terms which comprise keywords of the active display area. Since none of the entries from one of the five display areas has yet been activated, the entire screen in FIG. 2 corresponds to the active display area. In addition, in the illustrated exemplary embodiment the entries 2.1 to 2.5 are assigned as global keywords to the third group of terms.

The third display area 230 is configured as an application area for displaying details and controlling a selected and activated application. The number and the position as well as the graphic representation of the entries to be displayed are dependent on the activated application 2.1 to 2.5. The graphic representation and controllability of the third display area 230 are variable and can therefore be well matched to a greatly varying functionality or requirements of the various applications 2.1 to 2.5.

The fourth display area 240 is configured as a function line for displaying and selecting functions and/or subfunctions and/or options of an activated application 2.1 to 2.5. The number and the position and the graphic representation of the entries to be displayed, i.e. of the functions and/or subfunctions are dependent on the activated application 2.1 to 2.5 and/or on the menu level. The graphic basic structure is constant over all menu levels of the menu structure.

The fifth display area 250 is configured as a main application line. A presettable application can be displayed in this display area 250. The number and the position of the entries 5.1 to 5.7 to be displayed are constant for the preset application, and the contents and the graphic representation of the entries 5.1 to 5.7 to be displayed are variable and/or constant as a function of current system states. The preset application is preferably used to control an air conditioning system in the vehicle. The entry 5.1 (air conditioning) which can be selected and/or activated by means of a voice input is identified by bold and is assigned to the first and third groups of terms. The displayed values of a set parameter, such as for example air temperature, blower setting etc., can vary. The current system states relate in particular to states which are relevant to temperature control in the passenger compartment of a vehicle such as, for example, the external temperature, intensity of solar radiation, temperature of the passenger compartment, air humidity etc.

FIG. 4 shows the screen display 2 in a further menu level after the entry 2.2 (audio) in the second display area 220 has been selected by pushing the manual actuating means 3 in the positive x direction and has been activated by pressing the manual actuating means 3, or has been selected and activated by voice input of the entry 2.2 “audio”. Activation of the entry 2.2 opens and activates the application menu assigned to the entry 2.2 in the display area 220.1. In the application menu 220.1, for example six entries are displayed and these are assigned to the third group of terms, one entry “radio” of which being selected. This is indicated by the circle in front of it. Since the corresponding display area 220.1 is active, the entries of the application menu 220.1 in this menu level are additionally assigned to the first group of terms. The activation of the entry 2.2 “audio” causes the entries 4.1 to 4.4 of the function line which are associated with the radio application selected in the application menu 220.1 to be displayed in the fourth display area 240. The entries 4.1 to 4.4 of the function line are assigned to the second group of terms as local keywords which are associated with the radio application. Furthermore, activation of the entry 2.2 “audio” causes the display area 230.1 which is associated with the selected radio application to be opened in the third display area 230. The entries transmitters to transmitters which are shown in the opened display area 230.1 correspond to selectable radio stations. In the screen display 2 which is shown in FIG. 4, the entries of the application menu 220.1 which is currently active can be selected and activated with the manual actuating means 3 by means of a corresponding adjustment movement. In addition, the active display area 220.1 can be exited and closed again by means of a corresponding adjustment movement. By means of a voice input it is possible for an entry in the screen display 2 shown in FIG. 4 to be selected from the display area 220.1 and activated, as a result of which the application menu is subsequently exited and closed. In addition, by inputting one of the global keywords from the third area of terms which comprises the entries of the application line 2.1 to 2.5 which can be input by voice, of the main application line 250 and the entries of the application menus which are assigned to the respective applications and which can be input by voice it is possible to change into another display area. In this way it is possible, for example by inputting one of the keywords by voice, to change from the application line 220 into an application menu, assigned to the input entry, for a further control operation, as a result of which the currently active display area 220.1 is also exited and closed. A voice input of one of the local keywords from the second group of terms, for example one of the entries from the display area of the function line 240, causes the assigned function to be activated. This makes clear how a rapid changeover between the applications and thus between the individual menu levels is possible through the inventive grouping of the keywords without running backwards through the menu structure. In order to indicate that the application menu 20.1 is active, the other display areas can be subdued, for example can be displayed with a darker color and/or the application menu 220.1 can be visually highlighted, for example can be displayed in a brighter color. As a result, it is clear to the user, in particular even an unpracticed user, that a corresponding manual input or voice input for selecting an entry from the application menu 220.1 is expected from him in this menu level.

Through the manual activation or through the activation by voice input of the entry “radio” which is selected in the application menu 220.1, the user arrives at the screen display 2 which is illustrated in FIG. 1 and in which the application “radio” of the application group “audio” is active with the settings which were set before the application was exited last.

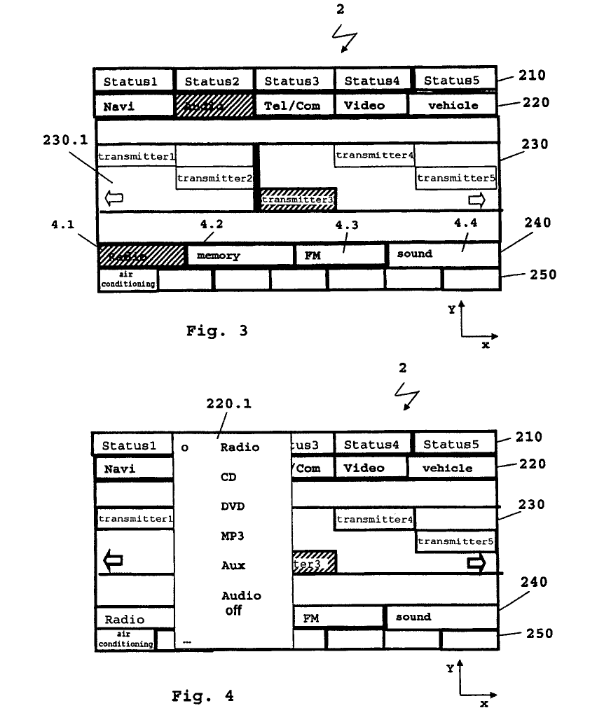

The user also arrives at the screen display illustrated in FIG. 3 if he inputs the global keyword “radio” in the first menu level from FIG. 2 by means of a voice input. In FIG. 3, the application group 2.2 “audio” in the application line 220 is selected and the function “radio” which is assigned to the application “radio” is selected in the function line 240. In the display area 230, the entry “transmitters” in the display area 230.1 is selected and activated by means of the cursor illustrated as a perpendicular bar. The transmitter setting can be made by means of a corresponding manual adjustment process with the manual actuating means 3 or by inputting the local keyword “next transmitter”. The currently displayed keywords of the first area of terms are the entries 4.1 to 4.4 of the function line 240 which are marked by bold and which are opened if one of the functions is activated by correspondingly selecting and activating the assigned entry from the function line 240. In the illustrated exemplary embodiment, the entries of the display area 230.1 cannot be controlled by voice input since the rule applies that within the display area 230 only entries which are displayed as a vertical list or horizontal list can be controlled by voice input. However, in an alternative embodiment it is possible to provide for all text entries of the third display area 230 to be able to be controlled by voice input.

The keyword “radio” is an example of different functionalities which can be assigned to a keyword. When the keyword “radio” in FIG. 4 is input by voice, the radio application is activated, the application menu 220.1 is closed and the system changes to the display according to FIG. 3. When the keyword “radio” in FIG. 3 is input by voice, a function menu of the radio application (not illustrated) is opened for the purpose of further control, in which case for example a transmitter search, transmitter save process etc. can be selected and/or activated in this function menu.

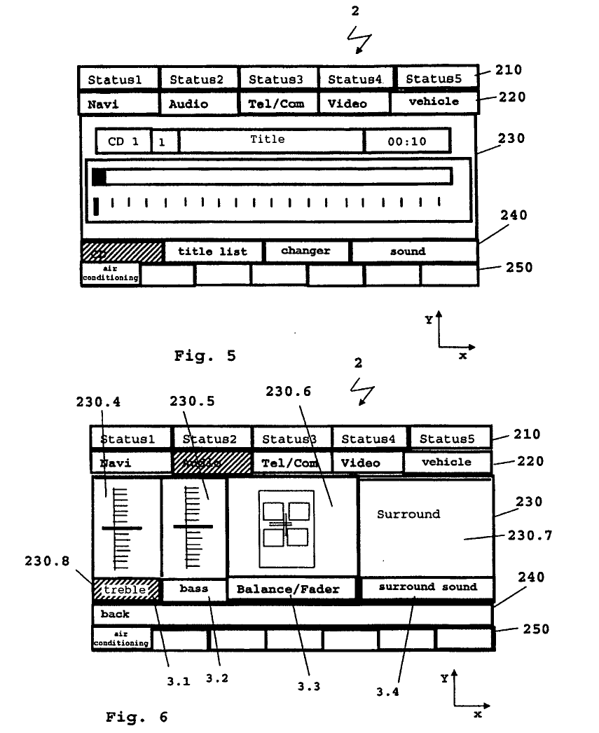

If the user inputs the global keyword “CD” in the screen display 2 from FIG. 2 or 3 (said keyword is not illustrated there) from the audio application menu 220.1, he arrives at the screen display 2 from FIG. 5. This screen display is reached even if the entry “CD” illustrated in the application menu 220.1 from FIG. 4 is selected in said menu by voice input or manual input and activated. The subapplication “CD” is carried out with the settings which were set before the subapplication was exited last. In the screen display 2 from FIG. 3, the application “audio” in the application line 220 and the entry “CD” in the function line 240 are selected. Two further display areas 230.2 and 230.3 which display the settings of the subapplication “CD” are displayed in the display area 230. The entries of the application line 2.1 to 2.5, of the function line 4.1 to 4.4 and the entry 5.1 of the main application “air conditioning system”, are marked by bold in the screen display and can be input as keywords by voice input. In addition, all the local and global keywords can be input.

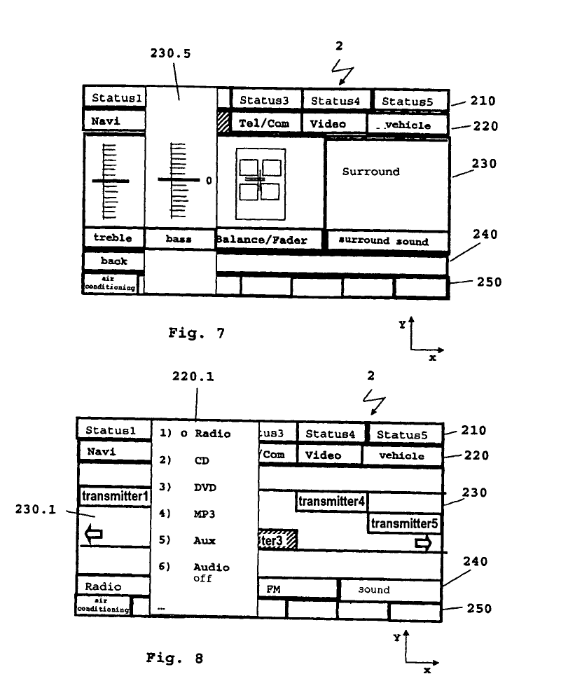

If the local keyword “sound” is input in one of the menu levels from FIG. 3 or 5, the screen display 2 changes into the menu level from FIG. 6. As is apparent from FIG. 6, four display areas 230.4 “treble”, 230.5 “bass”, 230.6 “balance/fader” and 230.7 “surround sound” in this menu level are displayed for the selection and/or activation and/or setting of associated subfunctions in the active third display area 230. In the second menu line 220, the activated application 2.2 “audio” is activated, which is indicated by the hatched display of the associated field. In the subfunction line 231 of the third display area 230, the selected subfunction 3.1 “treble” is correspondingly marked by a hatched display. One of the displayed entries 3.1 to 3.4 from the subfunction line can be by means of a corresponding manual input with the manual actuating means 3 or by a voice input using the voice control system. Moreover, the local and global keywords mentioned above can be input. In FIG. 6, a further global keyword “back” is displayed in the subfunction line 240. This keyword leads in all the menu levels to a return to the previous display on the screen display 2. If in the screen display 2 displayed in FIG. 6 the subfunction “bass” is selected and activated, for example by a manual input or by a voice input, the screen display 2 shows the display according to FIG. 7.

As is apparent from FIG. 7, the display area 230.5 there is activated in order to set the subfunction “bass” parameter. This is indicated to the user by a display area 230.5 which is enlarged compared to the display from FIG. 6. The subfunction can now be set with the manual actuating means 3. The subfunction “bass” parameter is currently set to the value 0. If a submenu is configured as a list with text entries as in FIG. 7 or 8, the number of entries can be unlimited, the number of maximum visible entries being limited, for example to nine entries. When there are more than nine entries, an entry can be selected by scrolling. The indication that further invisible entries are present can be provided by means of arrows. In order to be able to scroll by voice input, a corresponding keyword can be displayed next to the arrow, for example “forward” or “back”.

FIG. 8 shows a representation of the screen display in the menu level from FIG. 3 in which, in contrast to the representation from FIG. 3, the individual list elements of the application menu 220.1 are identified by numbering placed in front of them. In the illustrated exemplary embodiment, the numbering is implemented by a rising numerical sequence. However, it is alternatively also possible to use letters to identify the individual list elements. In addition, the numbering can also be placed after the individual list elements. The numbering indicates to the user both that the list elements can be selected and/or activated by voice input and that the selection and/or activation can also be carried out by voice input of the corresponding character, i.e. number of letter, which is assigned to the desired list element.

Basically, all the displayed entries 1.1 to 5.7 can be selected with the manual actuating means 3. Only a small number of status displays and options which are not available at certain times are exempted. Not all entries displayed can be selected by rotation. In each display area 210 to 250 only a number of elements which are correspondingly graphically highlighted can be selected directly by rotation. The other entries are firstly activated by pushing the manual actuating means 3 orthogonally with respect to the graphically highlighted area. The activity state, i.e. the possibility of direct selection, of a display area 210 to 250 or of individual entries is displayed, for example, by different colored elements and different graphic elements.

In at least one of the display areas 210 to 250, the cursor is not an independent object on the screen display 2 but rather assumes the shape of the field in which it is positioned. In the described configuration, this applies to the first, second, fourth and fifth display areas 210, 220, 240, 250. The cursor is displayed by changing the graphic representation of the field on which it is positioned, for example by changing the color of the background of the respective entry 1.1 to 5.7, with the inversion of the colors of the display of the entry 1.1 to 5.7. The positioning of the cursor on a field represents the selection of the entry associated with this field. It is possible to depart from this display if a parameter setting can already be implemented by rotating or pushing the cursor, or if the entry is represented graphically instead of as text. In this case, the cursor is displayed with a different graphic form. This type of cursor display can be limited spatially to the third display area 230.

The cursor is always positioned within what is referred to as an active display area 210 to 250, i.e. in a display area 210 to 250 which can be controlled directly and in which one of the entries can be selected and/or activated by rotating and pushing the manual actuating means 3 either horizontally or vertically as a function of the orientation of the entries 1.1 to 5.7. This active display area 210 to 250 is orientated either vertically or horizontally.

The entries of the active display area 210 to 250 can be highlighted through color, for example by a light script and/or icons and/or graphics on a dark background, text entries corresponding to the keywords can be input by voice. In addition, this display area can be delimited by a horizontal or vertical light line which serves, for example, to indicate the direction of rotation. In the third display area 230, the activation state can be displayed by means of a highlighted entry and/or by means of the highlighted cursor.

The display areas 210 to 250 which are not directly active can be represented in a graphically subdued fashion, for example by means of a different color and/or different intensity. These unactivated display areas 210 to 250 can be selected by respectively orthogonally pushing the manual actuating means 3 with respect to the orientation of the entries in the active display area 210 to 250. Furthermore, it is possible to select the nonactive display areas 210 to 250 by a corresponding voice input of local or global keywords from the second or third group of terms.

Entries which cannot be selected for a certain time can nevertheless be displayed, for example, in an attenuated form with color contrast. The cursor cannot be moved onto such entries. These entries can, for example, be jumped over or the movement of the manual actuating means 3 can be limited, for example, in the form of a stop, which prevents the cursor being moved onto the field which cannot be selected. If such an entry is inadvertently input by voice input, the user receives the visual and/or audible message that the entry is not available at present. Likewise, it is possible to respond to voice inputs for the selection of nonimplemented components.

According to the invention, in the illustrated application in a motor vehicle possible global keywords of the third group of terms are the entries for the application groups navigation system 2.1, audio system 2.2, telephone/communication system 2.3, TV/video system 2.4, vehicle systems 2.5 and heating and air conditioning system 5.1. In addition, the entries of the application menus which are assigned to the application groups are global keywords from the third group of terms. The navigation application menu thus comprises, for example, global keywords for the selectable applications or options such as start navigation, abort navigation, show map, dynamic mode etc. The audio application menu comprises, for example, global keywords for the selectable applications or options such as radio, CD, audio, DVD, MP3, audio off etc. The telephone/communications application menu comprises, for example, global keywords for the selectable applications or options such as browser, address book, notebook, telephone, messages, radio services, telephone off etc. The TV/video application menu comprises, for example, global keywords for the selectable applications or options such as DVD, TV, video off, etc. The vehicle system application menu comprises, for example global keywords for the selectable applications or options such as setting exterior rear view mirror, nightlight time, surround lighting, tailgate boundaries etc. The global keywords are, as has already been stated above, recognized by the voice control means 6 in all the menu levels and passed on to the evaluation and control unit 4 in order to carry out the assigned functionality.

Possible local keywords for entries of the second group of terms are the entries in the function line 240 which are assigned to the applications. For example, the navigation application group in the function line comprises, for example when the navigation system is switched off, local keywords for the selectable functions or options such as position, destination, full image etc. When the navigation system is selected, the navigation application group in the function line 240 comprises, for example, local keywords for the functions or options such as route, position, repeat driving instruction, destination, full image etc. The audio application group comprises in the function line 240, when the application radio is selected, for example local keywords for the selectable functions or options such as radio, memory, sound, VHF etc. When the CD or DVD application is selected, the function line 240 comprises, for example, local keywords for the selectable functions or options such as CD, title list, changer, sound etc. For the selected application MP3, the function line 240 comprises, for example, local keywords for the selectable functions or options MP3, title, file, changer and sound. The telephone/communications application group comprises in the function line 240 for the selected application address book, for example, local keywords for the selectable functions or options such as search and new entry. The selected application news comprises in the function line 240, for example, local keywords for the selectable functions or options such as input, new, drafts, output, messages etc. The TV/video application group comprises in the selected application TV, for example, local keywords for the selectable functions or options such as memory, teletext, sound etc. The vehicle system application group comprises in the function line 240, for example, local keywords for the selectable functions or options for system settings and user profiles. The local keywords are, as has already been stated above, recognized by the voice control means 6 as a function of the menu level, i.e. the selected and activated application group, and passed on to the evaluation and control unit 4 for execution of the assigned functionality.

Possible keywords for entries of the first group of terms are the entries which are assigned to the functions in the associated function menu. The first group of terms comprises in the selected application group navigation keywords for a function menu for the inputting of addresses such as input location, street, house number, start navigation etc. as a function of the active display area 210 to 250, and in the case of a function menu for the destination memory it comprises the keywords delete, change etc. as a function of the active display area 210 to 250. In the selected application group audio, the first group comprises, for example, keywords for a function menu sound such as treble, bass, balance/fader etc. In the selected TV/video application group, the first group comprises, for example, keywords for a teletext function menu. In the selected vehicle system application group, the first group comprises, for example, keywords for a function menu password entry or for a function menu seat.

The configurations described with respect to the drawings show that the invention can be used to control a very wide variety of applications and/or functions. Dividing the selectable and/or activatable entries of a menu structure displayed on a screen display with a plurality of menu levels into various groups improves the intuitive voice control and the operating convenience both for an unpracticed user, to whom the possible keywords are displayed in the screen display which is currently being displayed, and for a practiced user who is allowed to jump over menu levels within the menu structure and also use voice to input terms which cannot be seen on the current screen display since it can be assumed that the practiced user has committed to memory at least selected keywords or keyword combinations after a certain period of use.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-16. (canceled)

17. A control system for a vehicle comprising:
a screen display with a plurality of display areas for displaying entries of a menu structure with a plurality of menu levels;
a manual actuating means for at least one of selecting and activating at least one entry in a current menu level from the menu structure;
voice control means for at least one of redundantly selecting and redundantly activating at least one entry from the menu structure which simultaneously forms a keyword for the voice control means, wherein
the entries of the menu structure are divided into various groups,
a first group comprising entries which can be at least one of selected and activated only with the manual actuating means,
a second group comprising entries which can be at least one of selected and activated with at least one of the manual actuating means and the voice control means, and
the second group is divided into at least two groups of terms defined by simple rules and which determine which keywords can be input at a particular time for the purpose of menu control.

18. The control system as claimed in claim 17, wherein keywords which are displayed on the screen display have an identifier.

19. The control system as claimed in claim 18, wherein a first group of terms comprises keywords which are displayed at a particular time in an active display area of the screen display and which are made available to the voice control means as a first partial vocabulary.

20. The control system as claimed in claim 19, wherein a second group of terms comprises local keywords which are made available to the voice control means as a second partial vocabulary in addition to the first partial vocabulary, and are dependent on the current menu level.

21. The control system as claimed in claim 20, wherein a third group of terms comprises global keywords which are made available to the voice control means as a third partial vocabulary in addition to the first and second partial vocabularies, and are independent of the current menu level and/or of the active display area.

22. The control system as claimed in claim 21, wherein when at least one of the keywords is input by voice, the same function is carried out as in the case of a corresponding manual input with the manual actuating means.

23. The control system as claimed in claim 22, wherein when at least one of the keywords is input by voice, a function which is restricted compared to a corresponding manual input is carried out, the restriction of the function being dependent on at least one of the current menu level and the active display area of the screen display.

24. The control system as claimed in claim 23, wherein the identification of the keyword in a displayed list is a numbering system of the entries which can be selected by voice input, it being possible to input the corresponding numeral or the corresponding entry by voice in order to select and/or activate an entry.

25. The control system as claimed in claim 24, wherein the identification of the entries which can be input by voice is a particular visual representation on the screen display.

26. The control system as claimed in claim 25, wherein the identification of the entries which input by voice is brought about by at least one of a different color, a different intensity, a different size and a different shape.

27. The control system as claimed in claim 26, wherein when a keyword which is assigned to at least two groups of terms is input, the function which is assigned to at least one of the current menu level and the active display area is carried out.

28. The control system as claimed in claim 27, wherein the screen display comprises five main display areas, the first group comprising entries of at least one of the first and of the third display area.

29. The control system as claimed in claim 28, wherein the second group comprises all the text entries of at least one of the first, second, third, fourth, and fifth display area.

30. The control system as claimed in claim 29, wherein the third group of terms comprises keywords for entries of at least one of the second and fifth display area.

31. The control system as claimed in claim 30, wherein the second group of terms comprises keywords for entries of at least one of the third, fourth, and fifth display area.

32. The control system as claimed in claim 31, wherein the groups of terms comprise keywords for dynamic entries which are dependent on at least one of current peripheral conditions and current system states.
